(19) United States
(12) Patent Application Publication
(10) Pub. No.: US 2016/0203212 A1
(43) Pub. Date: Jul. 14, 2016

(54) SYSTEM, METHOD AND COMPUTER PROGRAM PRODUCT FOR DETERMINING PREFERENCES OF AN ENTITY

(71) Applicant: Rajiv Motwani, Bangalore (IN)

(72) Inventor: Rajiv Motwani, Bangalore (IN)

(73) Assignee: MCAFEE, INC.

(21) Appl. No.: 11/551,648

(22) Filed: Oct. 20, 2006

(51) Int. Cl. G06F 17/30

(52) U.S. Cl. CPC G06F 17/30604; G06F 17/30864

(57) ABSTRACT

A system, method and computer program product are provided. In use, at least one preference associated with at least one first entity is identified. In addition, at least one preference associated with a second entity is determined. Further, the at least one preference associated with the second entity is determined based on the at least one preference of the at least one first entity.

### FIELD OF THE INVENTION

The present invention relates to preferences, and more particularly to determining preferences of various entities (e.g. individuals, organizations, etc.).

### BACKGROUND

Preferences have traditionally been utilized to define the needs and/or desires of entities (e.g. individuals, organizations, etc.). For example, preferences have been incorporated into applications, services, etc. for defining requirements of an entity associated therewith. Further, preferences have allowed appropriate content and/or services to be provided to an entity based on subjective input (e.g. provided by such entity, etc.). However, due to the subjective nature of such preferences, it has been impracticable to determine a preference associated with an entity without receiving manual input of such preference.

There is thus a need for overcoming these and/or other problems associated with the prior art.

### SUMMARY

A system, method and computer program product are provided. In use, at least one preference associated with at least one first entity is identified. In addition, at least one preference associated with a second entity is determined. Further, the at least one preference associated with the second entity is determined based on the at least one preference of the at least one first entity.

### BRIEF DESCRIPTION OF THE DRAWINGS

FIG. 1 illustrates a network architecture, in accordance with one embodiment.

FIG. 2 shows a representative hardware environment that may be associated with the server computers and/or client computers of FIG. 1, in accordance with one embodiment.

FIG. 3 shows a method for determining at least one preference of an entity, in accordance with one embodiment.

FIG. 4 shows a method for determining preferences of an entity based on another similar entity, in accordance with another embodiment.

FIG. 5 shows a graph for identifying a similar entity, in accordance with yet another embodiment.

FIG. 6 shows a method for identifying a service provider based on preferences of an entity, in accordance with still yet another embodiment.

FIG. 7 shows a method for interfacing an entity and a service provider, in accordance with another embodiment.

### DETAILED DESCRIPTION

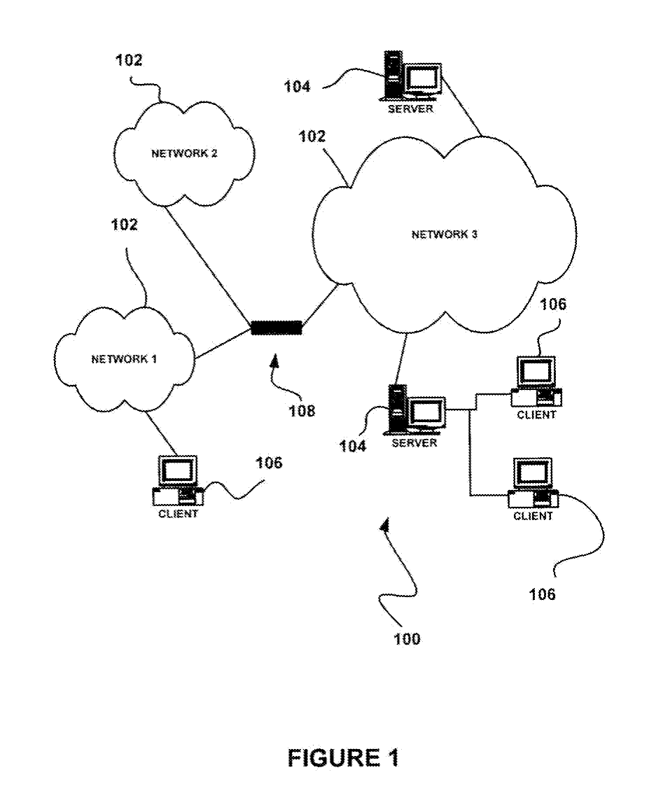

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are server computers 104 which are capable of communicating over the networks 102. Also coupled to the networks 102 and the server computers 104 is a plurality of client computers 106. Such server computers 104 and/or client computers 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

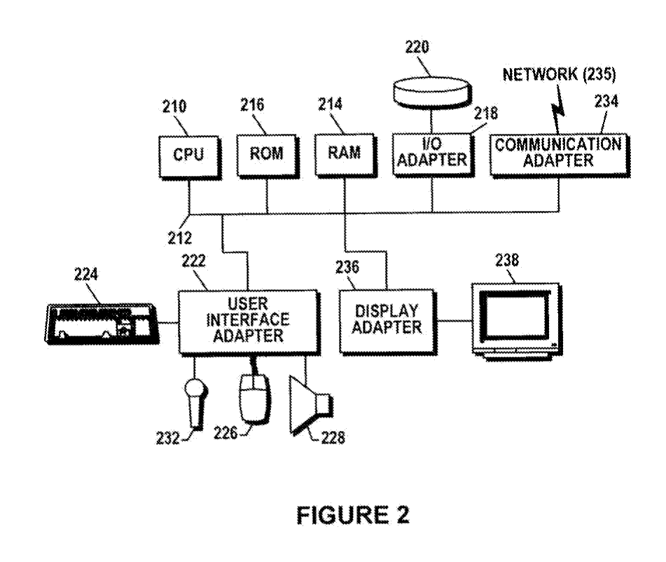

FIG. 2 shows a representative hardware environment that may be associated with the server computers 104 and/or client computers 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA. C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

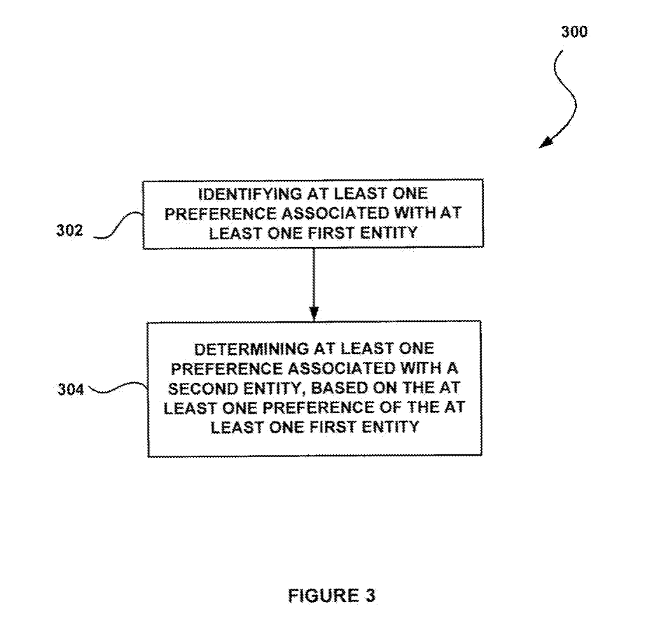

FIG. 3 shows a method 300 for determining at least one preference of an entity, in accordance with one embodiment. As an option, the method 300 may be implemented in the context of the architecture and environment of FIGS. 1 and/or 2. Of course, however, the method 300 may be carried out in any desired environment.

As shown in operation 302, at least one preference associated with at least one first entity is identified. The first entity may include an individual, a group/organization of individuals, a company, and/or any other entity capable of being associated with at least one preference. In addition, the preference may include any data representative of at least one preference associated with the first entity. For example, the preference may include a setting associated with the first entity.

In one embodiment, for example, the preference may include purchase information associated with the first entity. For instance, the preference may include information associated with a good and/or service purchased by the first entity. In the context of such purchase information, the preference may identify the good and/or service purchased by the first entity, a price paid by the first entity for such good and/or service, a quantity purchased by the first entity, a vendor of the good and/or service, etc.

In another embodiment, the preference may include information associated with the first entity that has been disclosed (e.g. provided, etc.) by the first entity to at least one other entity (e.g. information disclosed by an individual to a company, etc.). Such information may include personal information, financial information, demographic information, contact information, and/or any other information capable of being disclosed.

In yet another embodiment, the preference may include at least one recommendation made by the first entity. For example, the recommendation may include a recommendation associated with a good and/or service. As another example, the recommendation may include a recommendation associated with another entity.

Thus, the preference associated with the first entity may be based on prior actions of the first entity (e.g. purchases, information disclosures, recommendations, etc.). In this way, the preference may be generated automatically based on such actions. Of course, however, the preference associated with the first entity may also include a preference manually entered by the first entity. Such manually entered preference may include any data associated with the first entity, such as for example interests of the first entity, etc.

In a further embodiment, the preference may include a privacy preference of the first entity. Such privacy preference may optionally indicate information previously disclosed by the first entity. As another option, the privacy preference may indicate information which the first entity has authorized to be disclosed. For example, the information may include a name, an address, an age, an email address, a phone number, financial information, etc. of the first entity.

At least one preference associated with a second entity is then determined, based on the at least one preference of the at least one first entity. Note operation 304. The second entity may also include an individual, a company, and/or anything else that meets the aforementioned definition of the first entity, set forth above. Further, the preference may include any data representative of at least one preference associated with the second entity, including but not limited to, the types of preferences described above with respect to the first entity. Just by way of example, in various embodiments, the preference associated with the second entity may include a privacy preference, a vendor preference, a good and/or service preference, a price preference, an entity preference, etc.

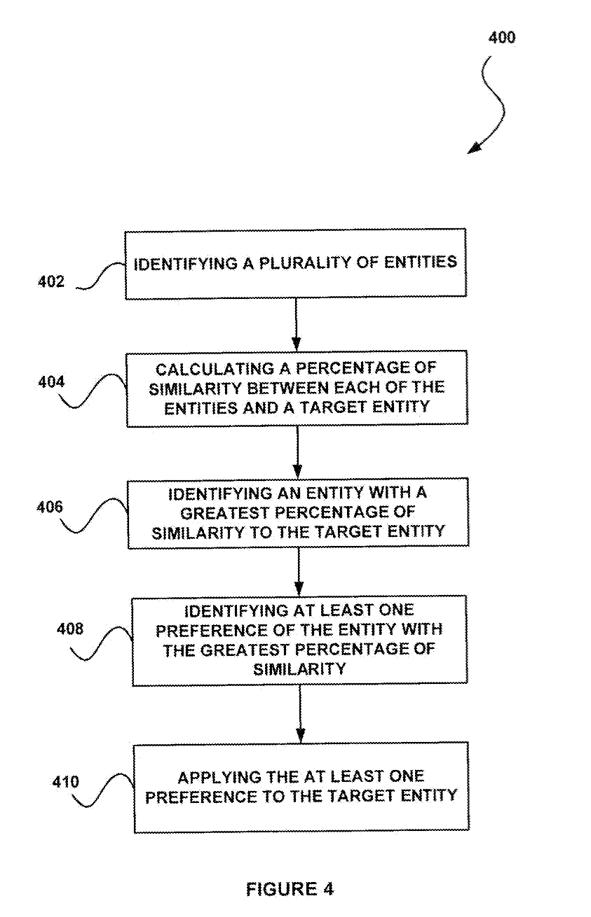

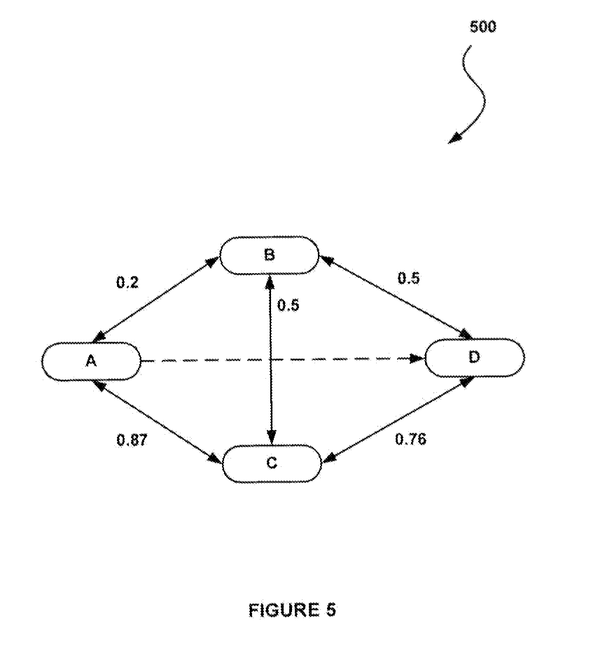

In the context of a privacy preference, for example, such privacy preference may optionally be utilized to identify information authorized by the second entity to be disclosed. Thus, in one embodiment, the privacy preference of the second entity may be determined based on a privacy preference associated with the first entity. More information on how such preference associated with the second entity may be determined will be described in more detail with respect to FIGS. 4 and 5.

In this way, preferences of an entity (e.g. the aforementioned second entity, etc.) may be automatically determined. As a result, in one possible embodiment, manual entry by an entity of one or more preferences may optionally be avoided while still accommodating such preference(s) for such entity. Therefore, a more efficient manner of determining preferences may be provided.

More illustrative information will now be set forth regarding various optional architectures and features of different embodiments with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 4 shows a method 400 for determining preferences of an entity based on another similar entity, in accordance with another embodiment. As an option, the method 400 may be implemented in the context of the architecture and environment of FIGS. 1-3. Of course, however, the method 400 may be carried out in any desired environment. It should also be noted that the aforementioned definitions may apply during the present description.

As shown in operation 402, a plurality of entities is identified. The entities may include individuals, companies, etc. and/or any combination thereof. As an option, the entities may be identified utilizing a database. For example, such database may include an entry for each entity and preferences associated therewith.

As another option, the entities may include entities located within a predefined radius of a location of a target entity. Such target entity may include any entity for which a preference is to be determined, for example. In addition, a percentage of similarity between each of the other entities and the target entity is calculated, as shown in operation 404. Of course, it should be noted that any type of similarity calculation may be utilized, and that the percentage of similarity described herein is just provided by way of example only.

In one embodiment, such percentage of similarity may be based on preferences common to another entity and the target entity. For example, such percentage of similarity may be based on actions (e.g. purchases, information disclosures, etc.) common to at least one other entity and the target entity. In this way, such percentage of similarity may be based on a similarity of decisions of the other entity and the target entity.

As another example, the percentage of similarity may be based on a commonality of manual preferences input by another entity and the target entity. Of course, however, any combination of different types of preferences may be utilized for determining a percentage of similarity between each entity in the plurality of other entities and the target entity. One example of calculating such percentage of similarity will be described in more detail with respect to FIG. 5.

The preferences of the other entities and the target entity may be identified in any desired manner, for calculating the similarity percentage of the present embodiment. In one embodiment, the preferences may be identified utilizing an agent installed on a computer of such entities. In another embodiment, the preferences may be identified by such entities logging into a service provider website for tracking such preferences and/or by capturing searches on a search engine. In yet another embodiment, the preferences may be identified by connecting to a computer of the entity, such as those described above with respect to FIG. 1, for example, via Bluetooth, etc. (or any other communication protocol) and tracking such preferences. Still yet, the preference may be identified utilizing data received from a service provider capable of tracking preferences of entities.

One or more of the other entities with a greatest percentage of similarity to the target entity is then identified, as shown in operation 406. Thus, an entity with preferences that are the most similar to the target entity is identified. Moreover, at least one preference of the other entity with the greatest percentage of similarity is identified, as in operation 408.

As described above, such preference may be identified utilizing preferences associated with the entity in a database. For example, such database may be inaccessible by/independent from such entities (e.g. stored on a separate server, etc.). Moreover, the identified preference may relate to a particular type of preference desired to be determined regarding the target entity. Thus, the identified preference may include a preference which is not common to the target entity.

Still yet, the at least one preference is applied to the target entity, as shown in operation 410. In one embodiment, the preference may be applied to the target entity by creating a preference for the target entity that is similar to (or even the same as) the preference of the other entity with the greatest similarity to the target entity. For example, the preference may be applied by adding the preference to a database of preferences associated with the target entity. In this way, a preference may be automatically determined for the target entity based on preferences of another entity that are similar to that of the target entity.

FIG. 5 shows a graph 500 for identifying a similar entity, in accordance with yet another embodiment. As an option, the graph 500 may be implemented in the context of the architecture and environment of FIGS. 1-4. Of course, however, the graph 500 may be carried out in any desired environment. It should also be noted that the aforementioned definitions may apply during the present description.

As shown, the graph 500 displays a plurality of entities (i.e. A, B, C, D). Of course, it should be noted that any number of entities may be included in the graph, and that the present embodiment is set forth for illustrative purposes only. The graph 500 may also include the percentage of similarity between each of the entities.

For example, as shown, the percentage of similarity between each of the entities may be known, except for that between entity A and entity D. The percentage of similarity may be based on a percentage of preferences that each set of entities have in common. Accordingly, in the context of the present description, a 100% similarity between two entities may mean that such entities have all of the same preferences. In this way, a percentage of similarity between entity A and entity D may be calculated based on an indirect path from entity A to entity D with the greatest percentage of similarity.

Table 1 shows an example of calculating a percentage of similarity between entity A and entity D. It should be noted that the information in Table 1 is set forth for illustrative purposes only, and is not to be construed as limiting in any manner.

TABLE 1

| Level 1: | A→D = % x |
|---|---|
| Level 2: | A→B and B→D = 0.2 * 0.5 = 0.1 |
| | A→C and C→D = 0.87 * 0.76 = 0.66 |
| Level 3: | A→B and B→C and C→D = 0.2 * 0.5 * 0.76 = 0.076 |
| Average Level 2: | (0.1 + 0.66)/2 = 0.38 |
| Average Level 3: | 0.076 |

Thus, A→D = 0.38 or 38% of similarity, which is the greatest percentage of similarity for a path from entity A to entity D.

As shown in Table 1, in the context of the present embodiment, the greatest percentage of similarity between entity A and entity D is 38%. When compared to the percentage of similarities of each of the other entities and entity D, it may be determined that entity C has the greatest percentage of similarity with entity D (e.g. 76% of similarity). Thus, the preferences of entity C are the most similar to the preferences of entity D, from which it may be determined that entity C is the most similar to entity D. Accordingly, as described above with respect to FIG. 4, at least one preference of entity D may be determined based on at least one preference of entity C.

As an option, the graph 500 may also be described utilizing a table, such as that shown in Table 2. Such table may include the percentage of similarity between entities, such that an unknown percentage of similarity between two entities may be identified, for example, in the manner described above with respect to Table 1. It should be noted that Table 2 is set forth for illustrative purposes only, and is not to be construed as limiting in any manner.

TABLE 2

| | A | B | C | D | S1 | S2 |
|---|---|---|---|---|---|---|
| A | — | 0.2 | 0.87 | ? | 0.4 | 0.2 |
| B | 0.2 | — | 0.5 | 0.5 | 0.5 | 0.3 |
| C | 0.87 | 0.5 | — | 0.76 | 0.7 | 0.2 |
| D | ? | 0.5 | 0.76 | — | 0.0 | 0.2 |
| S1 | 0.4 | 0.5 | 0.7 | 0.0 | — | 0.0 |
| S2 | 0.2 | 0.3 | 0.2 | 0.2 | 0.0 | — |

In the context of the present exemplary embodiment, since entity C's preferences are the most similar to entity D's preferences, entity C's preference for service provider 1 (S1) over service provider 2 (S2) may be identified. From such, it may be determined that entity D's preference for S2 is also outweighed by its preference for S1. Thus, a preference for entity D may be determined based on a preference of entity C.

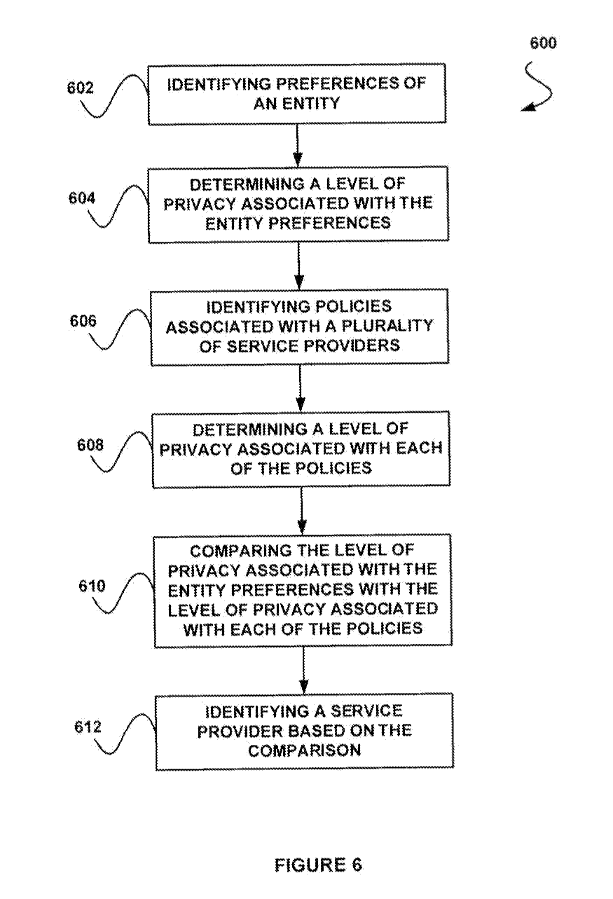

FIG. 6 shows a method 600 for identifying a service provider based on preferences of an entity, in accordance with still yet another embodiment. As an option, the method 600 may be implemented in the context of the architecture and environment of FIGS. 1-5. Of course, however, the method 600 may be carried out in any desired environment. It should also be noted that the aforementioned definitions may apply during the present description.

As shown in operation 602, preferences of an entity are identified. Such preferences may optionally be identified utilizing a database of entity preferences. In addition, a level of privacy associated with the entity preferences is determined, as shown in operation 604.

The level of privacy may be determined based on the entity preferences. For example, predetermined levels of privacy may be compared to the entity preferences. The level of privacy for which all of the entity preferences are included may then be identified.

In one optional embodiment, the predetermined levels of privacy may be defined based on types of data (e.g. types of data authorized to be disclosed by an entity, types of data not authorized to be disclosed by an entity, etc.). Such types of data may include personal information, contact information, financial information, etc.

Table 3 illustrates examples of levels of privacy and the types of data that may be utilized to define such levels of privacy. Again, it should be noted that such levels are set forth for illustrative purposes only, and should not be construed as limiting in any manner.

TABLE 3

| | |
|---|---|
| Level 1: | no disclosure of information |
| Level 2: | disclose preliminary contact information (e.g. email address, |
| | etc.) |
| Level 3: | disclose name, age, email address, phone number, etc. |

Thus, as shown in Table 3, an entity with preferences indicating that no information associated therewith be disclosed may be associated with Level 1, and so forth. In this way, a level of privacy may be determined for each entity based on the entity preferences.

Moreover, policies associated with a plurality of service providers are identified, as shown in operation 606. The service providers may include any entity capable of providing a good and/or service to the entity. In addition, the plurality of service providers may include service providers located within a predefined radius of the location of the entity, as an option. As another option, the service providers may include service providers that have made a request to receive entity information. As yet another option, the service providers may include service providers associated with a particular request by the entity. For example, the entity may request information from a particular category of service providers.

The policy of a service provider may define types of information required by such service provider for providing a service to an entity. Thus, for example, the policy may define types of information that an entity is required to disclose prior to utilization of a service provided by the service provider (which may include the receipt of goods, etc.). Further, such types of information may include personal information, contact information, financial information, etc.

Of course, it should be noted that each service provider may be associated with a single policy or a plurality of policies. For example, the service provider may have a single policy associated with a plurality of services, or may have a different policy associated with each service capable of being provided. Thus, different requirements for different services may be provided for. Still yet, each policy may define the usage of entity information by the service provider (e.g. third party disclosure, etc.).

Further, a level of privacy associated with each of the identified policies is also determined, as shown in operation 608. The level of privacy may be determined from predefined levels of privacy, such as those described above. Thus, each level of privacy may be associated with a level of information required by an entity to utilize an associated service [e.g. individual level of information, group level of information (level associated with a group of individuals), world level of information, etc.].

As described above, a level of privacy associated with a policy may include a level of privacy which includes all of the types of information required by the service provider. As another option, each level of privacy may specify minimum requirements identified by a law-making body (e.g. government, etc.). The level of privacy associated with the entity preferences is then compared to the level of privacy associated with each of the policies. Note operation 610.

As shown in operation 612, a service provider is identified based on the comparison. For example, a policy of a service provider associated with a privacy level that matches a privacy level of the entity preferences may be identified. In this way, the entity preferences may be utilized for identifying a service provider. In addition, the privacy levels may be utilized for identifying a service provider requiring types of information that the entity is willing to disclose.

Of course, it should be noted that a plurality of service providers may be identified based on the comparison. As an option, the plurality of identified service providers may be ranked. For example, such service providers may be ranked based on a particular aspect of the service providers (e.g. positive feedback associated therewith, vicinity to the entity, etc.). Moreover, the service providers may then be displayed to the entity for selection.

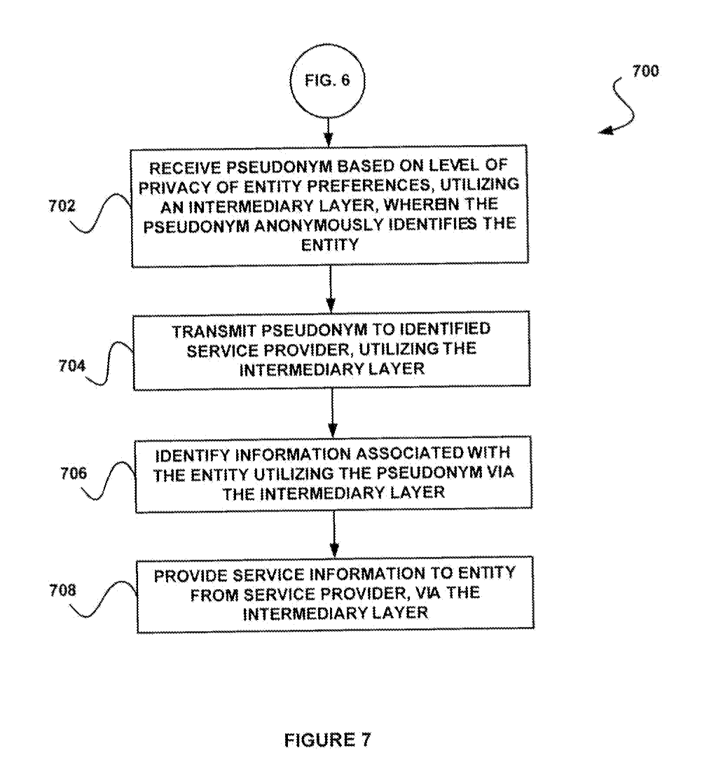

FIG. 7 shows a method 700 for interfacing an entity and a service provider, in accordance with another embodiment. As an option, the method 700 may be implemented in the context of the architecture and environment of FIGS. 1-6. Of course, however, the method 700 may be carried out in any desired environment. It should also be noted that the aforementioned definitions may apply during the present description.

As shown in operation 702, a pseudonym is received based on a level of privacy of entity preferences, utilizing an intermediary layer. The pseudonym may anonymously identify the entity. In addition, the pseudonym may anonymously identify information associated with the entity (e.g. personal information, financial information, contact information, demographic information, etc.).

In one embodiment, the pseudonym may be received from a collection of pseudonyms. For example, each level of privacy associated with policies of service providers may be associated with a different collection of pseudonyms. In a further embodiment, the number of pseudonyms in each collection may be associated with the number of entities with the level of privacy associated with such collection. Thus, for example, if one hundred entities are associated with a first level of privacy, then one hundred pseudonyms may be included in the collection of pseudonyms associated with such first level of privacy.

In this way, a random pseudonym from a collection of pseudonyms may be assigned to a particular entity for being used to interface between the entity and a service provider. To ensure anonymity, each pseudonym from the collection of pseudonyms may be used in rotation among entities of an associated privacy level. Additionally, each pseudonym may be associated with a time period during which the pseudonym may be utilized by the assigned entity. Accordingly, each of such entities may utilize a pseudonym for a limited amount of time, thus preventing public identification of a link between the entity and the pseudonym.

Further, the intermediary layer may include an application for interfacing between entities and service providers, as will be described in more detail below. The intermediary layer may also include a plurality of nodes, each node capable of providing such an interface. Moreover, each node may provide an interface to an entity based on the entity's location. For example, a node may be installed at a computer utilized by the entity, such as any of the computers described above with respect to FIG. 1.

Still yet, service providers and entities may be registered with the intermediary layer, such that only those registered may utilized such interface. Such registration may be provided in exchange for a periodic subscription payment. The pseudonym is then transmitted to an identified service provider, utilizing the intermediary layer, as shown in operation 704. The service provider may therefore receive an identifier that anonymously identifies an entity.

Information associated with the entity is further identified utilizing the pseudonym via the intermediary layer, as shown in operation 706. Such information may include, for example, any types of information associated with the preferences of the entity (e.g. contact information, etc.). Optionally, the information associated with the entity may be provided to the service provider (not shown).

As a further option, such information associated with the entity may be provided with predefined limitations (e.g. times of day, number of times information received, etc.). In addition, the information may include blacklist information, such that entities that behave maliciously may be blacklisted. For example, a service provider may utilize a feedback option to alter an entity's preferences to include negative feedback.

Service information is then provided to the entity from the service provider, via the intermediary layer, as in operation 708. Such service information may include, for example, an advertisement associated with the service provider, such that the advertisement may be targeted to the entity based on the entity preferences. In another example, the service information may include an offer by the service provider to pay the entity in exchange for the disclosure of information beyond that included in the preferences of the entity.

Still yet, the service information may include interactive content (e.g. survey, etc.) such that the entity may provide feedback to the service provider, for example, in exchange for an incentive. Of course, however, the service information may include any information capable of being provided by the service provider. In addition, the service information may be provided to the entity in any desired manner. For example, the service information may be provided to a computer utilized by the entity.

Optionally, the entity may rate the service provider based on utilization of a service of the service provider. Such rating may be provided to the intermediary layer, and the intermediary layer may calculate a score for associating with the service provider. In this way, entities may include a minimum score preference, such that only service providers meeting the preference may be allowed to provide service information to the entity.

In one exemplary embodiment, a store that desires to advertise to entities within a predefined vicinity may receive pseudonyms of entities associated with a preference that includes disclosing contact information. In another exemplary embodiment, a bank that desires to provide banking operations to entities may receive pseudonyms for entities associated with a preference that any information be disclosed, since the bank may require financial information, etc. of the entities in order to provide its services. In yet another exemplary embodiment, a manager that desires to receive information about a location of employees may receive pseudonyms for entities with a preference that location information be disclosed.

In this way, service providers may utilize information associated with entities according to the preferences of such entities. In addition, entities may receive privacy protection based on associated preferences. Furthermore, advertisers may use entity preferences for targeted advertising, as described above.

While various embodiments have been described above, it should be understood that they have been presented by way of example only, and not limitation. For example, the aforementioned preferences may be applied in any context [e.g. in a security application (antivirus, intrusion detection/prevention, etc.), search engine application, etc.]. Thus, the breadth and scope of a preferred embodiment should not be limited by any of the above-described exemplary embodiments, but should be defined only in accordance with the following claims and their equivalents.

1. A method, comprising:
identifying a plurality of entities;
calculating a percentage of similarity between each of the plurality of entities and a second entity;
identifying at least one first entity of the plurality of entities, at least in part based on a percentage of similarity between the at least one first entity and the second entity;
determining, utilizing a processor, a level of disclosure of information of the second entity, at least in part based on at least one privacy preference of the at least one first entity;
receiving a pseudonym based on the level of the disclosure of the information of the second entity, the pseudonym anonymously identifying the information; and
providing the disclosure of the Information of the second entity to a service provider.

2-7. (canceled)

8. The method of claim 1, wherein the information includes at least one of a name, an address, an age, and an electronic mail address.

9-10. (canceled)

11. The method of claim 1, wherein the similarity includes a similarity of decisions by the at least one first entity and the second entity.

12-14. (canceled)

15. The method of claim 1, wherein the service provider is identified by comparing the level of the disclosure of the information of the second entity to a policy of the service provider.

16. The method of claim 15, wherein the policy of the service provider indicates the level of the disclosure of the information by the second entity prior to a utilization of an associated service.

17. (canceled)

18. A computer program product, embodied on a non-transitory computer readable medium, that, when executed, causes a processor to perform a method comprising:
identifying a plurality of entities;
calculating a percentage of similarity between each of the plurality of entities and a second entity;
identifying at least one first entity of the plurality of entities, at least in part based on a percentage of similarity between the at least one first entity and the second entity;
determining a level of disclosure of information of the second entity, at least in part based on at least one privacy preference of the at least one first entity;
receiving a pseudonym based on the level of the disclosure of the Information of the second entity, the pseudonym anonymously identifying the Information; and
providing the disclosure of the information of the second entity to a service provider.

19. A system, comprising:
at least one processor configured to identify a plurality of entities, to calculate a percentage of similarity between each of the plurality of entities and a second entity, to identify at least one first entity of the plurality of entities, at least in part based on a percentage of similarity between the at least one first entity and the second entity, to determine a level of disclosure of information of the second entity, at least in part based on the at least one privacy preference of the at least one first entity, to receive a pseudonym based on the level of the disclosure of the information of the second entity, the pseudonym anonymously identifying the information, and to provide the disclosure of the information of the second entity to a service provider.

20. The system of claim 19, further comprising:
a display and memory coupled to the at least one processor via a bus.

21-25. (canceled)

26. The method of claim 1, wherein a level of disclosure of information of the at least one first entity indicates whether the information of the at least one first entity is authorized to be disclosed, and the pseudonym is a random pseudonym from a collection of pseudonyms and is assigned for a time period during which the pseudonym may be utilized by the second entity.

27. The computer program product of claim 18, wherein the information includes at least one of a name, an address, an age, and an electronic mail address.

28. The computer program product of claim 18, wherein the similarity includes a similarity of decisions by the at least one first entity and the second entity.

29. (canceled)

30. The computer program product of claim 18, wherein the service provider is identified by comparing the level of the disclosure of the information of the second entity to a policy of the service provider.

31. The computer program product of claim 30, wherein the policy of the service provider indicates the level of the disclosure of the information by the second entity prior to a utilization of an associated service.

32. The computer program product of claim 18, wherein, upon identifying the service provider, the pseudonym is provided to the service provider.

33. The computer program product of claim 18, wherein the at least one privacy preference associated with the at least one first entity is provided automatically at least in part based on previous entity activity, and the pseudonym is used for identification purposes for the second entity.

34. The computer program product of claim 18, wherein a level of disclosure of information of the at least one first entity indicates whether the information of the at least one first entity is authorized to be disclosed, and the pseudonym is a random pseudonym from a collection of pseudonyms and is assigned for a time period during which the pseudonym may be utilized by the second entity.

35. The system of claim 19, wherein the information includes at least one of a name, an address, an age, and an electronic mail address.

36. The system of claim 19, wherein the similarity includes a similarity of decisions by the at least one first entity and the second entity.

37. The system of claim 19, wherein the service provider is identified by comparing the level of the disclosure of the information of the second entity to a policy of the service provider.

38. The system of claim 37, wherein the policy of the service provider indicates the level of the disclosure of the information by the second entity prior to utilization of an associated service.

39. The system of claim 37, wherein, upon identifying the service provider, the pseudonym is provided to the service provider.

40. The system of claim 19, wherein the at least one privacy preference associated with the at least one first entity is provided automatically at least in part based on previous entity activity, and the pseudonym is used for identification purposes for the second entity.

41. The system of claim 19, wherein a level of disclosure of information of the at least one first entity indicates whether the information of the at least one first entity is authorized to be disclosed, and the pseudonym is a random pseudonym from a collection of pseudonyms and is assigned for a time period during which the pseudonym may be utilized by the second entity.
